(19) United States
(12) Patent Application Publication
(10) Pub. No.: US 2021/0356061 A1
(43) Pub. Date: Nov. 18, 2021

(54) CONNECTION ASSEMBLY

(71) Applicant: EUGEN FORSCHNER GMBH, Spaichingen (DE)

(72) Inventor: Sander NIKOLOV DONAYRE, Spaichingen (DE)

(73) Assignee: EUGEN FORSCHNER GMBH, Spaichingen (DE)

(21) Appl. No.: 17/286,205

(22) PCT Filed: Oct. 18, 2019
(86) PCT No.: PCT/EP2019/078420

§ 371 Date: Apr. 16, 2021

(30) Foreign Application Priority Data
Oct. 19, 2018 (DE) 10 2018 126 101.2
Oct. 29, 2018 (DE) 10 2018 126 886.6

(51) Int. Cl. F16L 25/01; F16L 37/084; H01R 13/00

(52) U.S. Cl. CPC F16L 25/01; H01R 2103/00; H01R 13/005; F16L 37/0841

(57) ABSTRACT

The invention relates to a connection assembly with a fluid plug and a fluid connector, said fluid connector being used to at least partly received the fluid plug. The connection assembly also comprises an electric plug and a receiving socket, wherein the receiving socket is used to at least partly receive the electric plug. The fluid plug and/or the fluid connector has a holder for the electric plug or the receiving socket, and the electric plug and/or the receiving socket is movably mounted relative to the other independently of a movement of the fluid connector and/or the fluid plug relative to the paired holder.

The invention relates to a connection assembly in accordance with the preamble of claim 1 and a method for connecting or disconnecting such a connection assembly in accordance with the invention claims 9 and 10.

A connection assembly of the generic type is known from EP 2 463 566 B1. Said connection assembly is a connection assembly for simultaneously connecting a fluid line and an electrical line. This is particularly of advantage for fluid lines in the case of heatable connection assemblies. It is a disadvantage of the said embodiment that the two lines are disconnected simultaneously. Thus there is for example the risk of a short circuit or of the electrical contacts becoming corroded if the escaping fluid—in particular if it contains urea—drips onto the connection components of the electrical line.

The object of the invention is to provide a safe and reliable connection assembly and a method for releasably connecting or disconnecting a fluid line and an electrical line that is connected thereto.

This object is achieved in accordance with the invention by means of a connection assembly having the features of claim 1 and by means of a method having the features of claim 11 or 12. Advantageous embodiments of the invention are disclosed in the dependent claims that respectively relate thereto.

A preferred area of application of the invention are applications in the automotive industry, in particular in the case of heatable fluid lines for AdBlue® and their connection to connectors or connection elements, wherein the fluid lines are provided there with electrical heating conductors and in order to realize a functional connection it is necessary to perform a connection of the fluid-carrying part and also of the electrical current lines.

It is possible with the present invention to provide a connection assembly having a fluid male connector, which is arranged on a first line section of a fluid line, and having a fluid connector that is arranged on a second line section of a fluid line, said connection assembly also comprising an electrical male connector for at least one electrical line and a receiving socket for at least one electrical line. In this case, the fluid connector is used to receive at least in part the fluid male connector and the receiving socket is used to at least in part receive the electrical male connector. The electrical male connector or the receiving socket is in this case movable relative to one another independently from a movement of the fluid connector or of the fluid connector. This renders possible a temporal separation of the disconnecting procedures of the fluid-carrying components and of the electrical current-carrying components with the result that residual fluid is prevented from penetrating into the connection components of the electrical line.

In accordance with the invention, the fluid male connector and/or the fluid collector comprises a holder for the electrical male connector or the receiving socket and the electrical male connector or the receiving socket are mounted so as to be able to move—in particular to be displaced—with respect to their allocated holder. As a consequence, the connection assembly renders it possible in a first connecting position to simultaneously connect the fluid-carrying components and the electrical current-carrying components, in a second connecting position however said connection assembly renders it possible in the case of a disconnecting procedure by means of a relative movement of one of the electrical current-carrying components relative to its holder to disconnect the fluid-carrying components separately from separating the electrical current-carrying components.

In one advantageous development, the electrical male connector and/or the receiving socket can be removed from the holder. This means a high degree of flexibility during the procedure of assembling and dismantling the connection assembly during maintenance and/or repair work on the vehicle.

It has shown itself to be particularly advantageous in this case that at least one of the holders comprises a fastening device for the electrical male connector and/or for the receiving socket. It is thus possible to fix the electrical male connector or the receiving socket in a safe and reliable manner on the respective allocated holder. The fastening device is in this case preferably formed by a recess and at least one protrusion, wherein during the connecting procedure the at least one protrusion engages in the respective recess. A front end of the protrusion is in this case preferably rounded, so that a front collar of the electrical male connector can be easily released from the holder.

It is furthermore particularly advantageous that at least one of the holders surrounds at least in part the electrical male connector and/or the receiving socket. It is thus ensured that the electrical male connector and/or the receiving socket are positioned in a stable manner in the corresponding holder in a common axis. The fluid connection and the electrical connection are consequently positioned clearly in a parallel arrangement.

In a particularly preferred development of the invention, the electrical male connector comprises a latching device that can be brought into engagement with a mating latching device on the receiving socket. By virtue of the latching device and the mating latching device engaging with one another, the connection assembly is connected for the electrical line. In order to release the connection assembly, it is necessary to easily manually raise the latching device—preferably by means of the blade of a screwdriver—so that said latching device can be separated from the mating latching device—for example a latching lug. Alternatively, a resiliently mounted tilting lever is also suitable as a latching device that can be manually actuated without the assistance of a tool.

Further preferred is an embodiment of the electrical male connector having at least two or multiple poles; in an alternative embodiment, the electrical male connector can also be provided with only one pole, for example in the case of an application for signal transmission.

It is preferred that the fluid male connector is in the form of an SAE male connector, which preferably in the form of a rapid connection for fluid lines—for example for AdBlue®—can be used in vehicles.

The methods for connecting and disconnecting the connection assembly are of particular advantage for the user. During the connecting procedure, the electrical male connector and the receiving socket and also the fluid male connector and the fluid connector can be brought into engagement simultaneously. During the disconnecting procedure, the fluid male connector and the fluid connector can be disengaged prior to the electrical male connector and the receiving socket. Consequently, during the disconnecting procedure the fluid line is separated first and the electrical line is only subsequently separated. This renders it possible to separate the fluid pathway that is formed by the fluid male connector and the fluid connector prior to disconnecting the electrical current pathway that is formed by the electrical male connector and the receiving socket. The risk of a short circuit as a result of fluid possibly escaping during the disconnecting procedure of the fluid pathway is consequently eliminated because the electrical current pathway initially remains connected and as a consequence is still protected in a sealed manner against any escaping fluid.

An exemplary embodiment of the invention is further explained below with reference to the drawings. In the drawings:

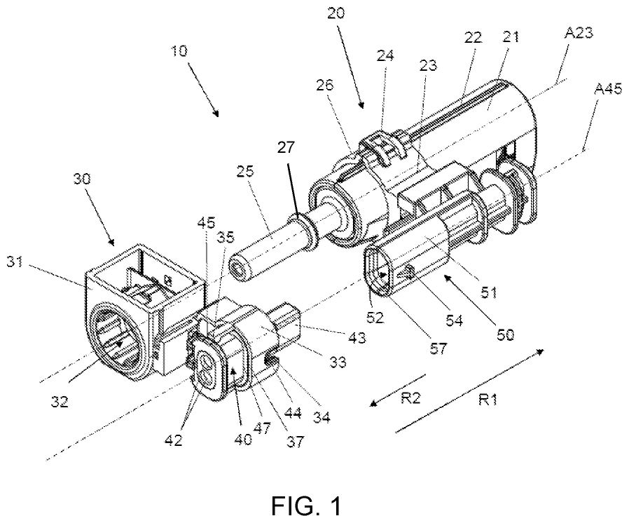

FIG. 1 illustrates a perspective view of the connection assembly in a position prior to the connecting procedure;

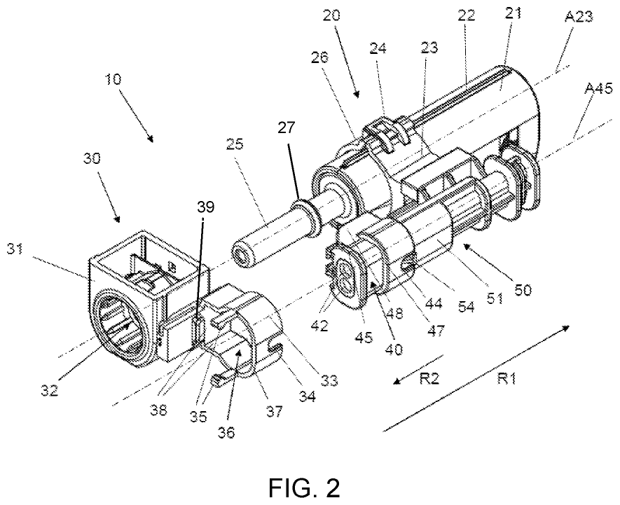

FIG. 2 illustrates a perspective view of the connection assembly after the procedure of disconnecting the fluid-carrying components and prior to the procedure of disconnecting the electrical male connector from a receiving socket; and

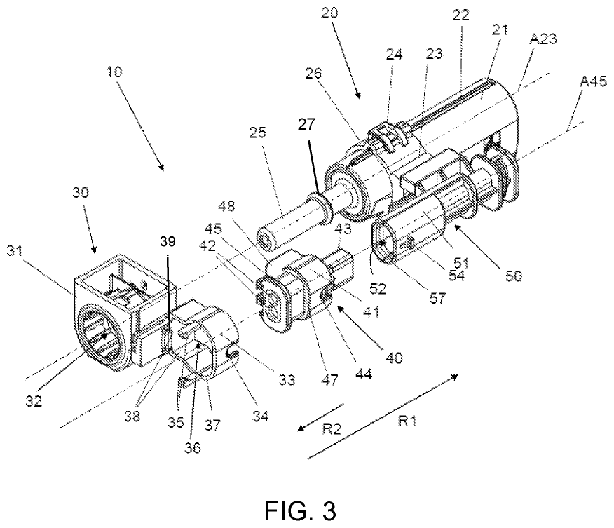

FIG. 3 illustrates a perspective view of the connection assembly with the electrical male connector disconnected from the receiving socket and prior to said electric male connector being re-inserted into the holder on the fluid connector.

FIG. 1 illustrates a connection assembly 10 having a fluid male connector 20, a fluid connector 30, an electrical male connector 40 and a receiving socket 50. In this case, the connection assembly 10 is illustrated in a so-called starting position. This means that the electrical male connector 40 is arranged in a holder 33 on the fluid connector 30 (left hand side of FIG. 1), said holder comprising an opening 36 (cf. FIG. 2). The fluid connector 30 and the fluid male connector 20 are arranged in this case in an axis A23 that is arranged parallel to an axis A45 of the electrical male connector 40 and the receiving socket 50.

In the illustrated exemplary embodiment, a protective cap 21 that surrounds in part the fluid male connector 20 and is used as a housing is arranged on the fluid male connector 20 and a rib-shaped rail 22 is provided on the protective cap 21. Alternatively, the protective cap 21 can also be embodied in two parts or with a flexible connection, wherein the rail 22 is then preferably formed as a film hinge. In accordance with a further alternative, the protective cap 21 can also be broader toward the rear—in other words at the end of the protective cap 21 that is opposite a front end 25 of the fluid male connector 20 and is arranged on the right hand side in the drawings.

Furthermore, a holder 23 and also a closing element 24 are provided for example in the form of a latching bracket, wherein the holder 23 engages around the protective cap 21 by means of a clamp like fastening 26. The clamp-like fastening 26 is closed in the region of the rail 22 by means of the closing element 24. In this case, prior to the closing procedure, it is possible by virtue of displacing the closing element 24 along the rail 22 to adjust the axial connecting distance of the electrical current-carrying components 40 and 50 and consequently to adapt it to the coupling distance of the fluid-carrying components 20 and 30.

Alternatively, the holder 23 can also be arranged fixedly on the fluid connector 20 and in this case the receiving socket 50 can be arranged in an adjustable manner on the holder 23.

The front end 25 of the fluid male connector 20 faces the direction of the fluid connector 30. The fluid connector 30 is formed by a housing 31 having an opening 32 and a holder 33 that is arranged on the housing 31 and is used to receive the electrical male connector 40. The construction and function of the fluid connector 30 are described in detail for example in WO 2016/038226 A1, the content of which in this respect is part of the disclosure content of this application. The front end 25 is in this case fixed with its protruding collar 27 in the opening 32 of the fluid connector 30 by means of a spring-like connecting element.

Two hook-shaped protrusions 35 that extend parallel to the axis A45 are arranged on the holder 33 and each of said protrusions comprises on their front end a rounded lug that protrudes inward. Furthermore, a U-shaped notch 34 is provided on the holder 33 on the side remote from the receiving socket 50.

The electrical male connector 40 that in FIG. 1 is inserted into the holder 33 comprises in the illustrated exemplary embodiment two poles 42 that are used so as to provide the connection to a respective electrical conductor (not illustrated). A recess 45 on the electrical male connector 40 is arranged directly below the protrusion 35 of the holder 33 for an engagement of the fastening device that is formed by the recesses 45 and the protrusions 35. A collar 41 (cf. FIG. 3) of the electrical male connector 40 is arranged on the inner wall of the holder 33 and preferably has the identical width as the holder 33. Consequently, a collar 37 of the holder 33 and a collar 47 of the electrical male connector 40 terminate flush in one plane and a latching device 44 is arranged in a congruent manner with the notch 34.

The receiving socket 50 that is arranged on the holder 23 of the fluid male connector 20 and has a housing 51 comprises an opening 52, a mating latching device 54 and a rim 57.

In an alternative exemplary embodiment, the holder 23 can also be embodied as a separate component. Furthermore, a one piece construction of fluid male connector 20 and receiving socket 50 is also possible, wherein the holder 23 is then embodied as a bridge-like binding element between the two.

The procedure of connecting the two fluid-carrying components 30 having 40 that are illustrated in FIG. 1 and the two electrical connecting elements 20 having 50 is performed in a direction R1. In this case, the fluid connector 30 is pushed onto the front end 25 of the fluid male connector 20 and a rear end 43 of the electrical male connector 40 is inserted into the opening 52 of the receiving socket 50. The electrical connecting elements 40 and 50 are latched via the latching device 44 of the electrical male connector 40 and the mating latching device 54 of the receiving socket 50. The mating latching device 54 can be embodied in this case as a resilient latching hook. As an alternative thereto, the mating latching device 54 is embodied as a fixed component and a latching device 44 that is embodied for example as a resilient tongue engages around it.

In the state in which the connection of the connection assembly 10 is complete, the latching device 44 of the electrical male connector 40 is congruent with the notch 34 of the holder 33. This state is not illustrated in FIGS. 1 to 3.

The connection assembly 10 is latched together overall by means of the spring-like connecting element—for example in the form of a latching spring—(not illustrated but described in WO 2016/038226 A1), wherein the front end 25 of the fluid male connector 20 is received in a sealing manner and fixed with its protruding collar 27 by means of the spring-like connecting element in the opening 32 of the fluid connector 30.

FIG. 2 illustrates the connection assembly 10 in a first disconnecting position in which the electrical male connector 40 is still connected to the receiving socket 50 but the fluid connector 30 has already been disconnected by means of disconnecting the latching spring (not illustrated) and a movement in the direction R2. In this case, the latching device 44 of the electrical male connector 40 is connected to the mating latching device 54 of the receiving socket 50. A guiding surface 48 of the electrical male connector 40 and guiding surfaces 38 of the fluid connector 30 render it possible to simply push (cf. FIG. 1) the electrical male connector 40 into the holder 33. It is thus possible to prevent the components tilting or rotating relative to one another.

In FIG. 3, in a second disconnecting position, the electrical male connector 40 is also disconnected from the receiving socket 50 and consequently is apparent as a dedicated—separate—component. In a next step of the disconnecting procedure, the electrical male connector 40 has been moved into the holder 33 of the fluid connector 30 and pushed into the opening 36 until the rim 47 lies against a stop rib 39 on the holder 33. It is now possible to repeat a further connecting procedure from the prepared connecting position illustrated in FIG. 1.

### LIST OF REFERENCE NUMERALS

10 Connection assembly
20 Fluid male connector
21 Protective cap
22 Rail
23 Holder
24 Closing element
25 (Front) end (of 20)
26 Fastening (clamp-like)
27 Collar
30 Fluid connector
31 Housing
32 Opening
33 Holder
34 Notch
35 Protrusion (common with 45 part of the fastening device)
36 Opening
37 Rim
38 Guiding surface
39 Stop rib
40 Electrical male connector
41 Collar
42 Pole
43 (Rear) end (of 40)
44 Latching device
45 Recess (common with 35 part of the fastening device)
47 Rim
48 Guiding surface
50 Receiving socket
51 Housing
52 Opening
54 Mating latching device
57 Rim
A23 Axis (through 20 and 30)
A45 Axis (through 40 and 50)
R1 (First) direction
R2 (Second) direction

1.-10. (canceled)

11. A connection assembly having a fluid male connector and a fluid connector, wherein the fluid connector is used so as to receive at least in part the fluid male connector, and having an electrical male connector and a receiving socket, wherein the receiving socket is used so as to receive at least in part the electrical male connector, wherein the fluid male connector and/or the fluid connector comprise a holder for the electrical male connector or the receiving socket and the electric male connector and/or the receiving socket are mounted so as to be able to move relative to one another with respect to their allocated holder independently of a movement of the fluid connector and/or of the fluid male connector in such a manner that in a first connecting position it is rendered possible to simultaneously connect on the one hand the fluid male connector and the fluid connector and on the other hand the electrical male connector and the receiving socket, and that in a second connecting position it is rendered possible in the case of a disconnecting procedure by means of a relative movement of the electrical male connector or the receiving socket with respect to the corresponding holder to disconnect the fluid male connector and the fluid connector separately from the procedure of separating the electrical male connector and the receiving socket.

12. The connection assembly as claimed in claim 11, wherein the electrical male connector and/or the receiving socket can be removed from the holder.

13. The connection assembly as claimed in claim 11, wherein at least one of the holders comprises a fastening device for the electrical male connector and/or the receiving socket.

14. The connection assembly as claimed in claim 13, wherein the fastening device is embodied by means of a recess and at least one protrusion.

15. The connection assembly as claimed in claim 11, wherein at least one of the holders surrounds the electrical male connector and/or the receiving socket at least in part.

16. The connection assembly as claimed in claim 11, wherein the electrical male connector comprises a latching device which can be brought into engagement with a mating latching device on the receiving socket.

17. The connection assembly as claimed in claim 11, wherein the electrical male connector comprises at least two poles.

18. A method for connecting a connection assembly as claimed in claim 11, wherein the electrical male connector and the receiving socket and also the fluid male connector and the fluid connector can be brought into engagement simultaneously during the connecting procedure.

19. A method for disconnecting a connection assembly as claimed in claim 11, wherein in a first disconnecting position the fluid male connector and the fluid connector can be disengaged prior to the electrical male connector and the receiving socket that can only be disconnected from one another in a second disconnecting position.

20. The connection assembly as claimed in claim 12, wherein at least one of the holders comprises a fastening device for the electrical male connector and/or the receiving socket.

21. The connection assembly as claimed in claim 12, wherein at least one of the holders surrounds the electrical male connector and/or the receiving socket at least in part.

22. The connection assembly as claimed in claim 13, wherein at least one of the holders surrounds the electrical male connector and/or the receiving socket at least in part.

23. The connection assembly as claimed in claim 14, wherein at least one of the holders surrounds the electrical male connector and/or the receiving socket at least in part.

24. The connection assembly as claimed in claim 12, wherein the electrical male connector comprises a latching device which can be brought into engagement with a mating latching device on the receiving socket.

25. The connection assembly as claimed in claim 13, wherein the electrical male connector comprises a latching device which can be brought into engagement with a mating latching device on the receiving socket.

26. The connection assembly as claimed in claim 14, wherein the electrical male connector comprises a latching device which can be brought into engagement with a mating latching device on the receiving socket.

27. The connection assembly as claimed in claim 15, wherein the electrical male connector comprises a latching device which can be brought into engagement with a mating latching device on the receiving socket.

28. The connection assembly as claimed in claim 12, wherein the electrical male connector comprises at least two poles.

29. The connection assembly as claimed in claim 13, wherein the electrical male connector comprises at least two poles.

30. The connection assembly as claimed in claim 14, wherein the electrical male connector comprises at least two poles.
